(19) United States
(12) Patent Application Publication
(10) Pub. No.: US 2011/0035036 A1
(43) Pub. Date: Feb. 10, 2011

(54) CONTROL APPARATUS, CONTROL METHOD, CONTROL PROGRAM AND NETWORK SYSTEM

(75) Inventor: Kinya Ono, Nishi-Tokyo (JP)

Correspondence Address: YOUNG & THOMPSON, 209 Madison Street, Suite 500, Alexandria, VA, 22314, US

(73) Assignee: PIONEER CORPORATION, Kawasaki-shi, Kanagawa (JP)

(21) Appl. No.: 12/937,441

(22) PCT Filed: Apr. 17, 2008
(86) PCT No.: PCT/JP2008/057515

§ 371 Date: Oct. 12, 2010

(51) Int. Cl. G06F 17/00; G05B 11/01

(52) U.S. Cl. 700/94; 700/19

(57) ABSTRACT

A control device applies an exclusive control to all controlled devices associated with a control sequence in executing the control sequence requiring a plurality of relevant control requests. More specifically, the control device eliminates the intervention of other control devices to the controlled devices during the period of the execution of the control sequence. This makes it possible to prevent the mismatching after the processing of the relevant control requests.

### TECHNICAL FIELD

The present invention relates to a method of establishing a plurality of connections.

### BACKGROUND TECHNIQUE

IEEE1394 is known as a high speed serial digital interface which transfers real-time data, such as video and audio, isochronously and transfers control data asynchronously. FIG. 1 shows an outline of IEEE1394 associated standards. In order to perform isochronous transfer by IEEE1394, it is necessary to establish a logical connection between a transmitting apparatus and a receiving apparatus of video and audio, and it is known as CMP (Connection Management Procedure) in IEC61883-1 as shown in FIG. 2.

The connection establishment is realized by associating, by channel information, a logical output plug of the transmitting apparatus with a logical input plug of the receiving apparatus, by using the transaction of IEEE1394. For the tranmission protocol of IEEE1394, at present, MPEG-2-TS, BT.601, DV are defined as video and A&M is defined as audio.

The control command specification on IEEE1394 is standardized by 1394TA (Trade Association), and a RESERVE command to realize an exclusive control is defined in “AV/C Digital Interface Command Set General Specification Version 4.2”.

By this command, a priority is set and the exclusive control can be performed according to the priority in the category of the control command by AV/C command. Also, as “AV/C Connection and Compatibility Management Specification 1.0”, a command set is defined to establish the ICE61883-1 connection on the receiving apparatus side by using AV/C command.

IEEE1394 is called i.LINK. As its transmission protocol, MPEG2-TS is used between a digital television and a DVH and a HDD recorder serving as a recording equipment, and DV is used in a digital handy camera. It is mainly used for a video recording purpose. In this case, audio is multiplexed to video, and they are transmitted as a single stream. The transmission of only audio is used as a digital interface between a DVD-Audio player and an AV amplifier.

When the above-mentioned video and audio are transmitted, it is necessary to establish one connection between the transmitting apparatus and receiving apparatus. For example, in a car AV system, when a controller (control apparatus) of a front monitor (hereinafter referred to as “F-monitor”) selects a DVD as a video transmitting apparatus, a rear monitor (hereinafter referred to as “R-monitor”) as a video receiving apparatus, the DVD as an audio transmitting apparatus and an amplifier as an audio receiving apparatus, the controller establishes two connections so as to transmit the video signal and the audio signal from one transmitting apparatus (the DVD) to two receiving apparatuses (the R-monitor and the amplifier). Namely, in such a case, it is necessary to establish the video connection and the audio connection, separately.

In this situation, if a user operates the controller of the R-monitor to watch the terrestrial digital broadcasting approximately at the same time, the controller selects a DTV (Digital TeleVison) as the video transmitting apparatus, the R-monitor as the video receiving apparatus, the DTV as the audio transmitting apparatus and the amplifier as the audio receiving apparatus, so as to establish the connections of the video signal and the audio signal at the same time.

Depending upon the execution timing of the connection establishing operation by each of the controllers, the operation from the controller of the F-monitor succeeds in establishing the video connection but fails in establishing the audio connection, and the operation from the controller of the R-monitor succeeds in establishing the audio connection but fails in establishing the video connection, reversely. However, there occurs such an inconsistency that each of the controllers recognizes that the connection establishing processes succeeded. The video connection and the audio connection are outputted from a single transmitting apparatus, and it is meaningful only when both of them are successfully established. Namely, both of the connection establishing operations failed.

As described above, conventionally, there occurs a problem such as an inconsistency in a series of control sequences over a plurality of apparatuses (a plurality of connection establishing processes of video and audio associated with each other).

It is noted that, for example, there is known a method of performing an exclusive control, in a system in which a digital television serves as the control apparatus and a DVHS serves as a controlled apparatus, so as to prevent that the user cannot perform the user's intended operation due to the control command from other control apparatus, during the control such as recording/reproduction by the digital television (See. Patent References 1 to 3). However, Patent References 1 to 3 are directed to the exclusive control of a single controlled apparatus, and their problem is different from that of the present invention.

### Patent Reference 1:

Japanese Patent Application Laid-open under No. 2003-87262

### Patent Reference 2:

Japanese Patent Application Laid-open under No. 2001-53766

### Patent Reference 3:

Japanese Patent Application Laid-open under No. 2001-243676

### DISCLOSURE OF INVENTION

### Problem to be Solved by the Invention

The above is one of the problem to be solved by the present invention. It is an object of the present invention to provide a control apparatus capable of preventing an inconsistency after processing a plurality of associated connections, in a series of control sequences over a plurality of apparatuses, by exclusively controlling a plurality of controlled apparatuses.

### Means for Solving the Problem

The invention of claim 1 is a control apparatus comprising an exclusive control means which exclusively controls all of controlled apparatuses related to a control sequence to exclude intervention by other control apparatus, during a control sequence executing period, at a time of executing the control sequence which needs a plurality of control requests associated with each other and executed by a control apparatus in a network including a plurality of control apparatuses and a plurality of controlled apparatuses.

The invention of claim 12 is a control method executed by a control apparatus, the method comprising an exclusive control process which exclusively controls all of controlled apparatuses related to a control sequence, during a control sequence executing period, to exclude intervention by other control apparatus, at a time of executing the control sequence which needs a plurality of control requests associated with each other and executed by the control apparatus in a network including a plurality of control apparatuses and a plurality of controlled apparatuses.

The invention of claim 13 is a control program executed by a control apparatus, making the control apparatus function as an exclusive control means which exclusively controls all of controlled apparatuses related to a control sequence, during a control sequence executing period, to exclude intervention by other control apparatus, at a time of executing the control sequence which needs a plurality of control requests associated with each other and executed by the control apparatus in a network including a plurality of control apparatuses and a plurality of controlled apparatuses.

The invention of claim 15 is a network system comprising a plurality of control apparatuses and a plurality of controlled apparatuses connected to communicate with each other via a network, one of the control apparatuses executing a control sequence to establish a connection to transmit a video signal and an audio signal on the network, wherein the controlled apparatuses include a video receiving apparatus which receives the video signal and an audio receiving apparatus which receives the audio signal, wherein the control apparatus comprises: a video exclusive control means which exclusively controls the video receiving apparatus to exclude intervention by other control apparatus, during a control sequence executing period; an audio exclusive control means which exclusively controls the audio receiving apparatus to exclude intervention by other control apparatus, during the control sequence executing period; a video connection establishment requesting means which requests the video receiving apparatus to establish the connection with the video transmitting apparatus which transmits the video signal; and an audio connection establishment requesting means which requests the audio receiving apparatus to establish the connection with the audio transmitting apparatus which transmits the video signal, wherein the video receiving apparatus comprises a video connection establishing means which establishes the connection with the video transmitting apparatus when receiving a request from the control apparatus, and wherein the audio receiving apparatus comprises an audio connection establishing means which establishes the connection with the audio transmitting apparatus when receiving a request from the control apparatus.

### BRIEF DESCRIPTION OF THE DRAWINGS

FIG. 1 is a diagram showing an outline of IEEE 1394 associated standard.

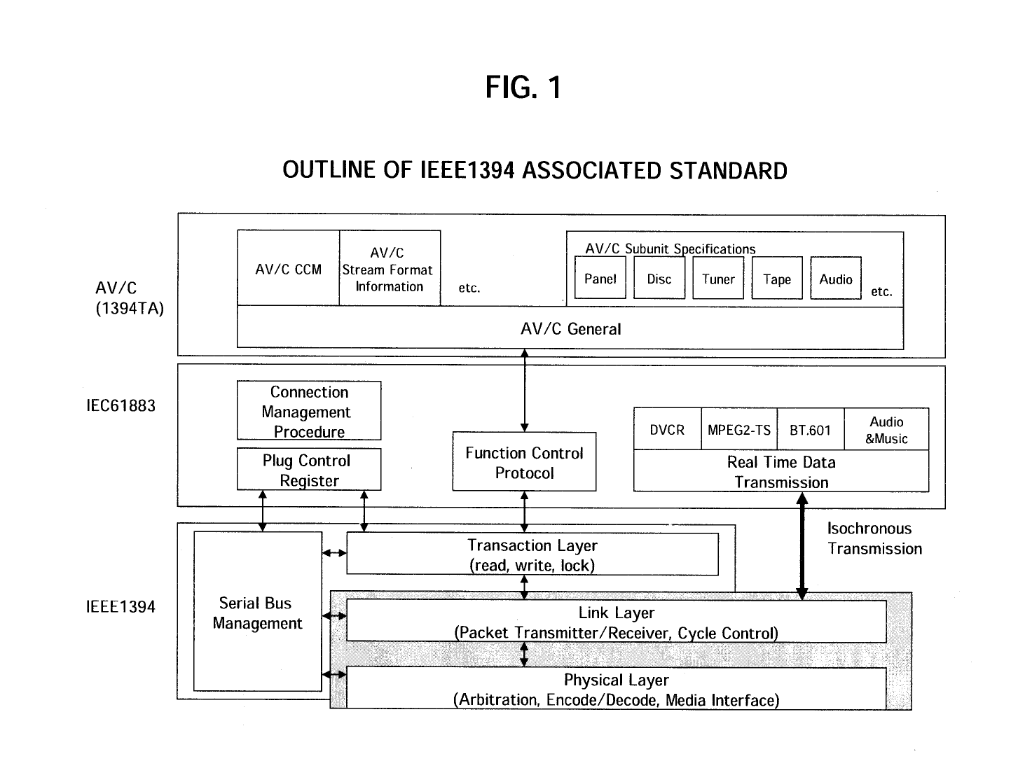

FIG. 2 is a diagram showing a configuration of CMP of IEC61883.

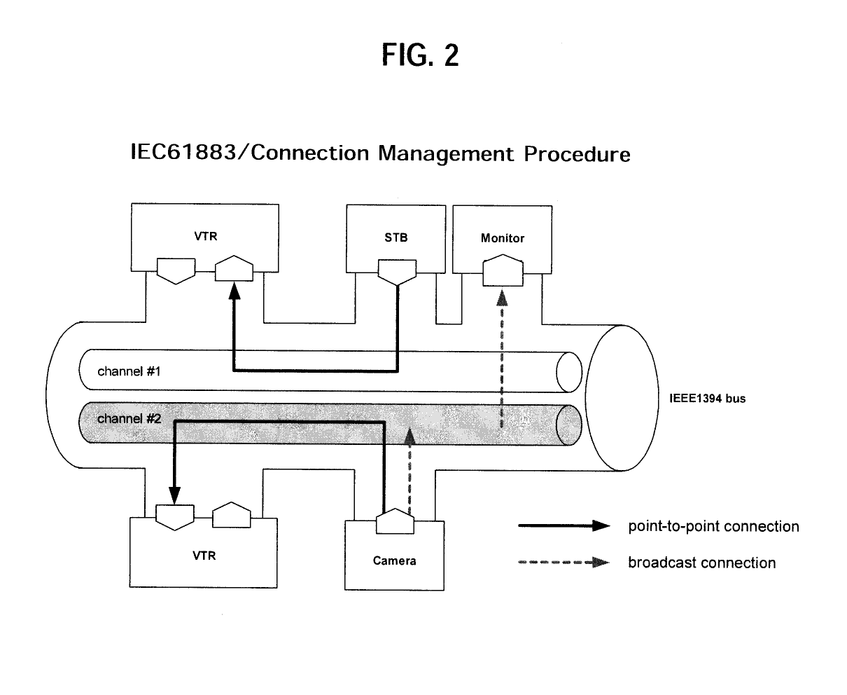

FIG. 3 is a diagram showing an example of a configuration of a car AV system according to an embodiment.

FIG. 4 is a block diagram showing a functional configuration of a control unit in the embodiment.

FIG. 5 is a sequence diagram of a connection establishing process in the car AV system.

FIG. 6 is a flowchart of the connection establishing process.

FIG. 7 is a flowchart of the connection establishing process.

FIG. 8 is a flowchart of the connection establishing process.

FIG. 9 is a flowchart of a connection process.

### DESCRIPTON OF REFERENCE NUMBERS

1 Car AV System

10 System Bus

11 Front Monitor

12 DVD Player

13 Car Navigation Apparatus

14 DTV

15, 16 Rear Monitor

17 Amplifier

18 Speaker

### MOST PREFERRED FORM TO EXERCISE THE INVENTION

According to one aspect of the present invention, there is provided a control apparatus comprising an exclusive control means which exclusively controls all of controlled apparatuses related to a control sequence to exclude intervention by other control apparatus, during a control sequence executing period, at a time of executing the control sequence which needs a plurality of control requests associated with each other and executed by a control apparatus in a network including a plurality of control apparatuses and a plurality of controlled apparatuses.

The control apparatus configured as described above executes the exclusive control of all of the controlled apparatuses related to a control sequence, at a time of executing the control sequence which needs a plurality of control requests associated with each other. Namely, the control apparatus excludes the intervention to the controlled apparatuses by other control apparatus, during the control sequence executing period. Therefore, it becomes possible to prevent the inconsistency after executing the plurality of associated processes.

In one mode of the above control apparatus, the control sequence is to establish a connection to transmit a plurality of associated signals on the network. By this, it is possible to prevent the inconsistency after executing the plurality of associated processes.

In another mode of the above control apparatus, the signals include a video signal and an audio signal, the controlled apparatuses include a video receiving apparatus which receives the video signal and an audio receiving apparatus which receives the audio signal, the exclusive control means comprises: a video exclusive control means which exclusively controls the video receiving apparatus to exclude the intervention by other control apparatus during the control sequence executing period; and an audio exclusive control means which exclusively controls the audio receiving apparatus to exclude the intervention by other control apparatus during the control sequence executing period, and the control apparatus comprises: a video connection establishment requesting means which requests, to the video receiving apparatus, to establish the connection with a video transmitting apparatus which transmits the video signal; and an audio connection establishment requesting means which requests, to the audio receiving apparatus, to establish the connection with an audio transmitting apparatus which transmits the audio signal.

In the control apparatus configured as described above, the video exclusive control means exclusively controls the video receiving apparatus which receives the video signal, during the control sequence executing period. Then, the video connection establishment requesting means requests the video receiving apparatus subjected to the exclusive control to establish the connection with the video transmitting apparatus which transmits the video signal. By this, the video receiving apparatus establishes the video connection for transmitting the video signal with the video transmitting apparatus. Also, the audio exclusive control means exclusively controls the audio receiving apparatus which receives the audio signal, during the control sequence executing period. Then, the audio connection establishment requesting means requests the audio receiving apparatus subjected to the exclusive control to establish the connection with the audio transmitting apparatus which transmits the audio signal. By this, the audio receiving apparatus establishes the audio connection for transmitting the audio signal with the audio transmitting apparatus. In this way, since the control apparatus exclusively controls, in advance, the receiving apparatus with which the connection is established, the intervention by other control device does not occur at the time of establishing the connection to transmit the audio signal and the video signal associated with each other. Therefore, it is possible to prevent such a situation that the video connection is established but the audio connection is not established for the video signal and the audio signal associated with each other.

In another mode of the above control apparatus, the signals include a clock signal for clock base jitterless transmission, wherein the controlled apparatus is the audio transmitting apparatus, wherein the audio exclusive control means exclusively controls the audio transmitting apparatus to exclude the intervention by other control apparatus during the control sequence executing period, and wherein the audio connection establishment requesting means requests, to the audio transmitting apparatus, to establish the connection with the audio receiving apparatus. By transmitting the exclusive control right setting request, including the connection establishment for transmitting the clock signal at the time of the clock base jitterless transmission, to the audio transmitting apparatus, it is possible to establish all of the connections necessary for a predetermined application without being affected by other control apparatus.

Another mode of the above control apparatus further comprises: a video connection establishment response means which receives, from the video receiving apparatus, a response indicating that the connection with the video transmitting apparatus is established; an audio connection establishment response means which receives, from the audio receiving apparatus, a response indicating that the connection with the audio transmitting apparatus is established; a video exclusive control releasing means which releases a exclusive control of the video receiving apparatus immediately after the video connection establishment response means receives the response; and an audio exclusive control releasing means which releases the exclusive control of the audio receiving apparatus immediately after the audio connection establishment response means receives the response.

In the control apparatus configured as described above, the video connection establishment response means receives, from the video receiving apparatus, the response indicating that the video connection with the video transmitting apparatus is established. Then, the video exclusive control releasing means immediately releases the exclusive control of the video receiving apparatus. Also, the audio connection establishment response means receives, from the audio receiving apparatus, the response indicating that the audio connection with the audio transmitting apparatus is established. Then, the audio exclusive control releasing means immediately releases the exclusive control of the audio receiving apparatus. In this way, by releasing the exclusive control of the receiving apparatus immediately after the connection is established, it is possible to minimize the influence on the receiving apparatus and other control apparatus.

In another mode of the above control apparatus, the exclusive control means includes an order setting means which sets an order of exclusive control for all of the controlled apparatuses related to the control sequence, and exclusively controls the controlled apparatuses in accordance with the order set by the order setting means to excludes the intervention by other control apparatus. By this, the control apparatus can secure the exclusive control right of the controlled apparatus having the order of high priority. Therefore, the success rate can be increased for the process of establishing a plurality of connections for transmitting the video signal and the audio signal associated with each other.

In another mode of the above control apparatus, the order setting means sets the order of the controlled apparatus, which easily causes conflict in the connection establishment, to have a high priority. By this, it is possible to secure the exclusive control right of the controlled apparatus which easily causes the conflict in establishing the connection.

In another mode of the above control apparatus, the control apparatus includes a history storage means which stores a history of success/failure of the exclusive control of the controlled apparatus by the exclusive control means, and the order setting means sets the order of the controlled apparatus, for which the exclusive control is rejected with high probability, to have a high priority, based on the history stored in the history storage means. By this, the control apparatus can secure the exclusive control right of the controlled apparatus with priority, for which obtaining the exclusive control right is difficult.

In another mode of the above control apparatus, when the video transmitting apparatus includes a plurality of internal sources, the video connection establishment requesting means designates any one of the internal sources and requests to establish the connection with the designated internal source as the video transmitting apparatus, and when the audio transmitting apparatus includes a plurality of internal sources, the audio connection establishment requesting means designates any one of the internal sources and requests to establish the connection with the designated internal source as the audio transmitting apparatus. In this way, when the transmitting apparatus includes a plurality of internal sources, by including the designation of the internal source in the video connection establishment request or the audio connection establishment request, it is possible to secure the exclusive control right of the transmitting apparatus.

Another mode of the above control apparatus, further comprises: a retry determining means which determines whether retry of connection establishment is possible or not, based on failure factor, when the connection establishment is failed; and a control sequence ending means which ends the control sequence when the retry determining means determines that the retry is not possible, and the video connection establishment requesting means and/or the audio connection establishment requesting means again requests the connection establishment after a constant waiting time passes, when the retry determining means determines that the retry is possible. By this, when the connection establishment is failed, if the retry of the connection establishment is possible based on the failure factor, the connection establishment is requested again to the receiving apparatus. Therefore, if the connection is successfully established by the retry, it is possible to omit the labor of requesting the selection operation to the user again. In addition, the success rate in the process of establishing the connection can be increased.

In another mode of the above control apparatus, the signals include an audio signal and a clock signal for clock base jitterless transmission, the controlled apparatuses includes an audio receiving apparatus which receives the audio signal and an audio transmitting apparatus which transmits the audio signal, and the exclusive control means includes: an audio exclusive control means which exclusively controls the audio receiving apparatus and the audio transmitting apparatus to exclude the intervention by other control apparatus, during a control sequence executing period; a first audio connection establishment requesting means which requests the audio receiving apparatus to establish the connection with the audio transmitting apparatus; and a second audio connection establishment requesting means which requests the audio transmitting apparatus to establish the connection with the audio receiving apparatus. By this, the exclusive control right setting request is transmitted, to the audio transmitting apparatus, for not only the connection establishment for transmitting the audio signal, but the connection establishment for transmitting the clock signal at the time of clock base jitterless transmission. Therefore, all of the connections necessary for a predetermined application can be established without being affected by other control apparatus.

According to another aspect of the present invention, there is provided a control method executed by a control apparatus, the method comprising an exclusive control process which exclusively controls all of controlled apparatuses related to a control sequence, during a control sequence executing period, to exclude intervention by other control apparatus, at a time of executing the control sequence which needs a plurality of control requests associated with each other and executed by the control apparatus in a network including a plurality of control apparatuses and a plurality of controlled apparatuses. Also by this method, it becomes possible to prevent the inconsistency after executing the plurality of associated processes.

According to still another aspect of the present invention, there is provided a control program executed by a control apparatus, making the control apparatus function as an exclusive control means which exclusively controls all of controlled apparatuses related to a control sequence, during a control sequence executing period, to exclude intervention by other control apparatus, at a time of executing the control sequence which needs a plurality of control requests associated with each other and executed by the control apparatus in a network including a plurality of control apparatuses and a plurality of controlled apparatuses. By executing the control program on the control apparatus, it becomes possible to prevent the inconsistency after executing the plurality of associated processes. The control program may be appropriately handled in a condition stored in a storage medium.

According to still another aspect of the present invention, there is provided a network system comprising a plurality of control apparatuses and a plurality of controlled apparatuses connected to communicate with each other via a network, one of the control apparatuses executing a control sequence to establish a connection to transmit a video signal and an audio signal on the network, wherein the controlled apparatuses include a video receiving apparatus which receives the video signal and an audio receiving apparatus which receives the audio signal, wherein the control apparatus comprises: a video exclusive control means which exclusively controls the video receiving apparatus to exclude intervention by other control apparatus, during a control sequence executing period; an audio exclusive control means which exclusively controls the audio receiving apparatus to exclude intervention by other control apparatus, during the control sequence executing period; a video connection establishment requesting means which requests the video receiving apparatus to establish the connection with the video transmitting apparatus which transmits the video signal; and an audio connection establishment requesting means which requests the audio receiving apparatus to establish the connection with the audio transmitting apparatus which transmits the video signal, wherein the video receiving apparatus comprises a video connection establishing means which establishes the connection with the video transmitting apparatus when receiving a request from the control apparatus, and wherein the audio receiving apparatus comprises an audio connection establishing means which establishes the connection with the audio transmitting apparatus when receiving a request from the control apparatus. Also by the above network system, it is possible to prevent such inconsistency that the video connection is established but the audio connection is not established, for the video signal and audio signal associated with each other.

### EMBODIMENT

A preferred embodiment of the present invention will be described below with reference to the attached drawings.

[Car AV System]

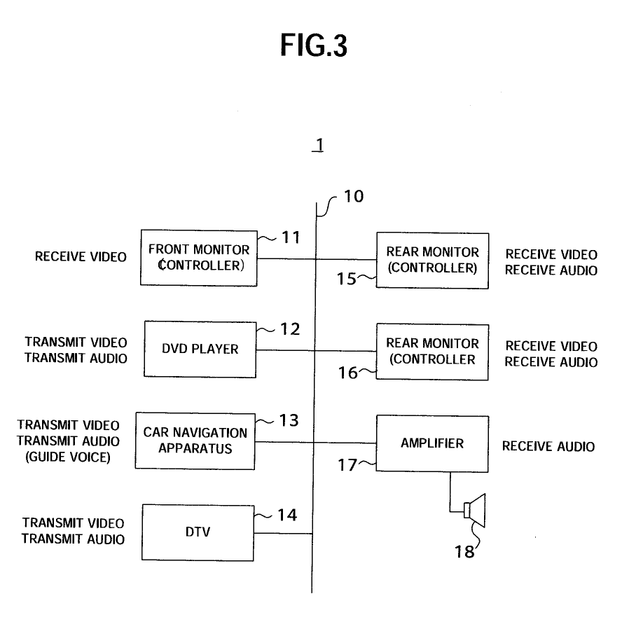

First, a configuration and prerequisites of a car AV (Audio Video) system 1 will be described with reference to FIG. 3. FIG. 3 is a diagram showing an example of a configuration of a car AV system 1 according to an embodiment of the present invention.

As shown in FIG. 3, the car AV system 1 includes a front monitor (hereinafter referred to as “F-monitor”) 11, a DVD player 12, a car navigation apparatus 13, a DTV (Digital TeleVison) 14, a rear monitor (hereinafter referred to as “R-monitor) 15, a R-monitor 16 and an amplifier 17, which are connected to each other via a system bus 10.

The F-monitor 11 is a video receiving apparatus which displays video on a display based on various video signals received from a video transmitting apparatus. The F-monitor 11 includes a graphic controller which performs the control of the F-monitor 11 based on the control signal transmitted from the controller via the system bus 10, a buffer memory which is a memory such as VRAM (Video RAM) and which temporarily stores the video signal promptly displayable, a display control unit which controls the display such as an LCD and a CRT (Cathode Ray Tube) based on the video signal outputted by the graphic controller, and a display. The display may be a liquid crystal display device mounted near the front panel in the vehicle compartment.

The DVD player 12 reads out contents data such as an audio signal and a video signal from a disc such as DVD under the control of the controller, and transmits it to the video receiving apparatus. The DVD player 12 is also an audio transmitting apparatus which transmits data to an audio receiving apparatus.

The car navigation apparatus 13 utilizes a GPS, vehicle speed pulses and a stand-alone measurement device such as a gyro-sensor, and performs a guidance such as a presentation of current position and a route guidance to a destination for the user during the driving of the vehicle. The car navigation apparatus 13 is an audio transmitting apparatus having guide voice necessary for the guidance, and reads out the corresponding audio signal to transmit it to the audio receiving apparatus. Also, the car navigation apparatus 13 is a video transmitting apparatus having map data necessary for the guidance, and reads out the corresponding video signal to transmit it to the video receiving apparatus.

The DTV 14 is an apparatus which receives a television broadcasting using a digital modulation and a digital compression (e.g., the terrestrial digital broadcasting in Japan). In the car AV system 1, the DTV 14 is an apparatus which transmits the audio signal of the received television broadcasting to the audio receiving apparatus. Also, the DTV 14 is a video transmitting apparatus which transmits the video signal of the received television broadcasting to the video receiving apparatus.

The amplifier 17 is connected to the on-vehicle speakers 18, and is an audio receiving apparatus which outputs audio via the on-vehicle speakers 18 based on the various audio signals received from the audio transmitting apparatus. The amplifier 17 includes a D/A (Digital to Analog) converter which performs the A/D conversion of the audio signal received via the system bus 10, under the control of the controller, and an amplifier which amplifies the audio analog signal outputted from the D/A converter.

R-monitors 15 and 16 are the video receiving apparatuses like the F-monitor 11, but are mounted on the rear area of the vehicle compartment. Also, the R-monitors 15 and 16 function as the audio receiving apparatus like the amplifier 17.

The F-monitor 11 and the R-monitors 15 and 16 have a HMI (Human Machine Interface) such as a touch-panel and buttons, and function as a controller to control the car AV system 1. The controller basically exists in the monitors and a H/U (Head Unit). While the controllers are the F-monitor 11 and the R-monitors 15 and 16 in this embodiment, the present invention is not limited to this. The apparatus which functions as a controller may be arbitrarily set.

Each controller can operate independently, and performs the recognition of the apparatuses on the network (system bus), the connection management of the apparatus subjected to the operation of the controller itself, the apparatus control, and the monitoring of the operation state of the apparatuses on the network. On the network, there are plural controllers which establish the connection between the apparatuses. Therefore, it is possible that the F-monitor 11 functions as the controller and selects the watching and listening source of the R-monitor 15, for example. The controller ensures an operationability like a remote controller, and has a “last-one-win” character that the last operation is valid.

As described above, according to the car AV system 1 of this embodiment, a plurality of apparatuses including the video transmitting apparatus, the audio transmitting apparatus, the video receiving apparatus and the audio receiving apparatus exist in a mixed manner on the network. It is assumed that the video signal and the audio signal are separately transmitted. The video signal and the audio signal maybe inputted to the video receiving apparatus and the audio receiving apparatus (e.g., the F-monitor 11 and the amplifier 17) separately, and may be inputted to the same apparatus (e.g., the R-monitor 15).

[Control Unit]

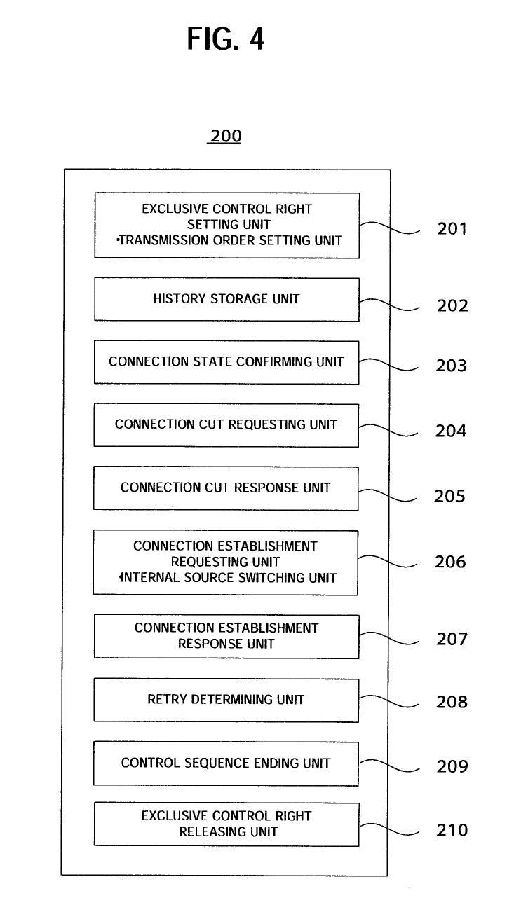

Next, a control unit 200 configured by the constitutional elements of the controller will be described with reference to FIG. 4. FIG. 4 is a block diagram of the control unit 200.

In a series of control sequence over the plural apparatuses, the control unit 200 exclusively controls a plurality of controlled apparatuses and establishes a plurality of associated connections. Here, the controlled apparatus is the receiving apparatus which is controlled by the controller and which establishes the connection with the transmitting apparatus.

As shown in FIG. 4, the control unit 200 includes an exclusive control right setting unit 201, a history storage unit 202, a connection state confirming unit 203, a connection cut requesting unit 204, a connection cut response unit 205, a connection establishment requesting unit 206, a connection establishment response unit 207, a retry determining unit 208, a control sequence ending unit 209 and an exclusive control right releasing unit 210.

The exclusive control right setting unit 201 transmits an exclusive control right setting request, to all of the controlled apparatuses related to the control sequence, in order to set the exclusive control right to exclude the intervention by other controller. Also, the exclusive control right setting unit 201 receives, from the controlled apparatus, the exclusive control right setting response indicating that the exclusive control right setting request is accepted and the exclusive control right is set (ACCEPTED) or that the exclusive control right setting request is rejected and the exclusive control right is not set (REJECTED).

Further, the exclusive control right setting unit 201 includes a transmission order setting unit. The transmission order setting unit sets the order with which the exclusive control right setting request is transmitted to all of the controlled apparatuses related to the control sequence. Specifically, the transmission order setting unit sets the order that the conflict of use on the car AV system 1 is easy to occur, to the order to transmit the exclusive control right setting request, so that the controlled apparatus can secure the exclusive control right in the order from the one easy to cause the conflict to the one uneasy to cause the conflict.

Specifically, in the car AV system 1, the transmitting apparatus can establish a plurality of connections by a single output plug (1:N connection), but the receiving apparatus can establish only one connection by a single input plug. Therefore, the conflict occurs more easily for the receiving apparatus than for the transmitting apparatus. Considering the type of the video receiving apparatus and the audio receiving apparatus, the conflict occurs more easily for the receiving apparatus, the number of which on the network is smaller. Based on this, the transmitting order setting unit sets the transmission order such that the conflict of the use on the car AV system 1 easily occurs. Then, the exclusive control right setting unit 201 transmits the exclusive control right setting request to the controlled apparatus in accordance with the transmission order set by the transmission order setting unit. It is noted that the transmission order setting unit may set the transmission order of a controlled apparatus, whose rejection probability is high, to be high based on the history of success or failure (i.e., accepted or rejected) of the exclusive control right setting request to each of the controlled apparatuses. The history is stored in the history storage unit 202.

The exclusive control right setting unit 201 functions as the exclusive control means, the video exclusive control means and the audio exclusive control means. Also, the transmission order setting unit functions as the order setting means, and the history storage unit 202 functions as the history storage means.

In this embodiment, in order to set the exclusive control right to exclusively control the connection operation, it is assumed to use the RESERVE command which is standardized by 1394TA (Trade Association) and defined in “AV/C Digital Interface Command Set General Specification Version 4.2” or a command set to establish the connection of IEC61883-1 defined in “AV/C Connection and Compatibility Management Specification 1.0” on the receiving apparatus side by using the AV/C command. However, since these commands exclusively control, not only the connection operation, but all the operations, the volume operation necessary for the user cannot be performed during the exclusive control, for example. Therefore, the present invention is not limited to the above, and a new command to exclusively control only the connection operation may be used.

The connection state confirming unit 203 transmits the connection state confirming request to confirm whether or not the controlled apparatus, to which the exclusive control right setting request is made by the exclusive control right setting unit 201, has already established the connection. Also, the connection state confirming unit 203 receives the connection state confirmation response indicating the connection state at the time of receiving the request, from the controlled apparatus. For example, in the case that the controlled apparatus is the amplifier 17 and it has already established the connection with the DTV 14, the connection state confirming unit 203 receives the connection state confirmation response indicating that the connection is being established with the DTV 14 (e.g., DTV-AMP). On the contrary, in the case that the controlled apparatus has not established the connection, the connection state confirming unit 203 receives the connection state confirmation response indicating that the connection is not being established (e.g., No Connection).

The connection cut requesting unit 204 transmits the connection cut request to cut the connection, when it is confirmed by the connection state confirming unit 203 that the controlled apparatus has already established the connection. The controlled apparatus cuts the connection when it receives the connection cut request.

The connection cut response unit 205 receives the connection cut response, from the controlled apparatus, indicating that the connection cut request is accepted and the connection is cut (ACCEPTED) or that the connection cut request is rejected and the connection is not cut.

The connection establishment requesting unit 206 transmits, to the controlled apparatus, the connection establishment request to establish the connection with the transmitting apparatus that is selected by the controller. For example, the connection establishment requesting unit 206 requests the receiving apparatus which is the controlled apparatus, to keep the frequency band and the channels from IRM (Isochronous Resource Manager) by using the transaction of IEEE1394, associates the logical output plug (oPCR[i]) of the transmitting apparatus with the logical input plug (iPCR [i]) of the receiving apparatus by the channel information, and executes the connection establishment. Specifically, the connection establishment requesting unit 206 requests the video receiving apparatus, which is the controlled apparatus, to establish the connection between the output plug of the video transmitting apparatus selected by the controller and the input plug of the video receiving apparatus. Also, the connection establishment requesting unit 206 requests the audio receiving apparatus, which is the controlled apparatus, to establish the connection between the output plug of the audio transmitting apparatus selected by the controller and the input plug of the audio receiving apparatus. Thus, the connection establishment requesting unit 206 requests to establish the connection to transmit the video signal and the audio signal, respectively.

When it is confirmed by the connection state confirming unit 203 that the connection has already been established, the connection establishment requesting unit 206 executes a new connection establishment request, requested by the controller, after the connection is cut in response to the connection cut request by the connection cut requesting unit 204. If the request by the controller is to cut the connection, the process of establishing the connection is not necessary.

The connection establishment requesting unit 206 functions as the video connection establishment requesting means and the audio connection establishment requesting means of the present invention.

Further, the connection establishment requesting unit 206 includes an internal source switching unit, a retry determining unit and a control sequence ending unit. The internal source switching unit switches the internal source if the transmitting apparatus has a plurality of video and audio sources (disc media, a memory device, a HDD (Hard Disc Drive), a tune, etc.). Namely, if the transmitting apparatus has a plurality of internal sources, the switching process of the internal source may be included in the connection establishing process. By this, the exclusive control right of the transmitting apparatus can be secured.

The connection establishment response unit 207 receives, from the controlled apparatus, the connection establishment response indicating that the connection establishment request is accepted and the connection is established (ACCEPTED) or that the connection establishment request is rejected and the connection is not established (REJECTED). The connection establishment response unit 207 functions as the video connection establishment response means and the audio connection establishment response means of the present invention.

When recognizing that the connection establishment is failed based on the connection establishment response received by the connection establishment response unit 207, the retry determining unit 208 determines whether or not the retry of the connection establishment can be executed, based on the failure factor. Specifically, if the failure factor is the lack of frequency band, etc., the retry determining unit 208 determines that the retry is impossible, and makes the control sequence ending unit 209 end the control sequence as the failure process. At this time, the control sequence ending unit 209 executes the cutting process of the connection established by the connection establishment request of the connection establishment requesting unit 206 and the warning display to the user. On the contrary, if the failure factor is the temporary rejection of the control command and the like and the process can be continued by the retry, the retry determining unit 208 determines that the retry of the connection establishment is possible, and executes the retry after the passage of a constant waiting time, while managing the number of times of the retry. The retry determining unit 208 functions as the retry determining means of the present invention. The control sequence ending unit functions as the control sequence ending means of the present invention.

When the connection establishment response unit 207 receives the connection establishment response (ACCEPTED) indicating that the connection is established, the exclusive control right releasing unit 210 immediately transmits the exclusive control right releasing request to release the exclusive control right of the controlled apparatus. Also, the exclusive control right releasing unit 210 receives, from the controlled apparatus, the exclusive control right releasing response indicating that the exclusive control right releasing request is accepted and the exclusive control right is released (ACCEPTED) or that the exclusive control right releasing request is rejected and the exclusive control right is not released (REJECTED). The exclusive control right releasing unit 210 functions as the video exclusive control releasing means and the audio exclusive control releasing means of the present invention.

As described above, in the connection establishment process of the associated video and audio, the control unit 200 secure the exclusive control rights of all the controlled apparatuses subjected to the control, and then executes the connection state confirmation, the connection cut and the connection establishment in response to the request related to the connection between the transmitting apparatus and the receiving apparatus selected by the controller. Further, the control unit 200 releases all of the exclusive control rights immediately after the establishment of the connection.

It is noted that each of the above-mentioned units are realized by the CPU of the controller which executes the program prepared in advance.

[Connection Establishing Process]

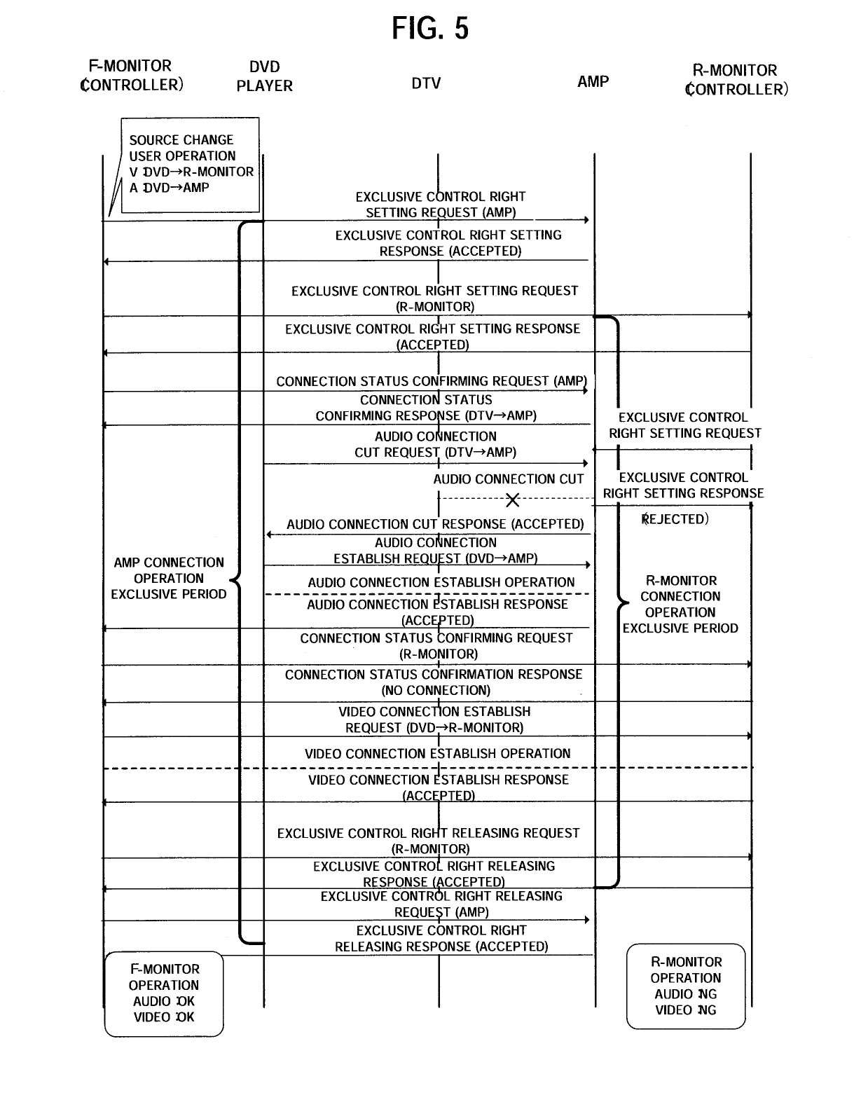

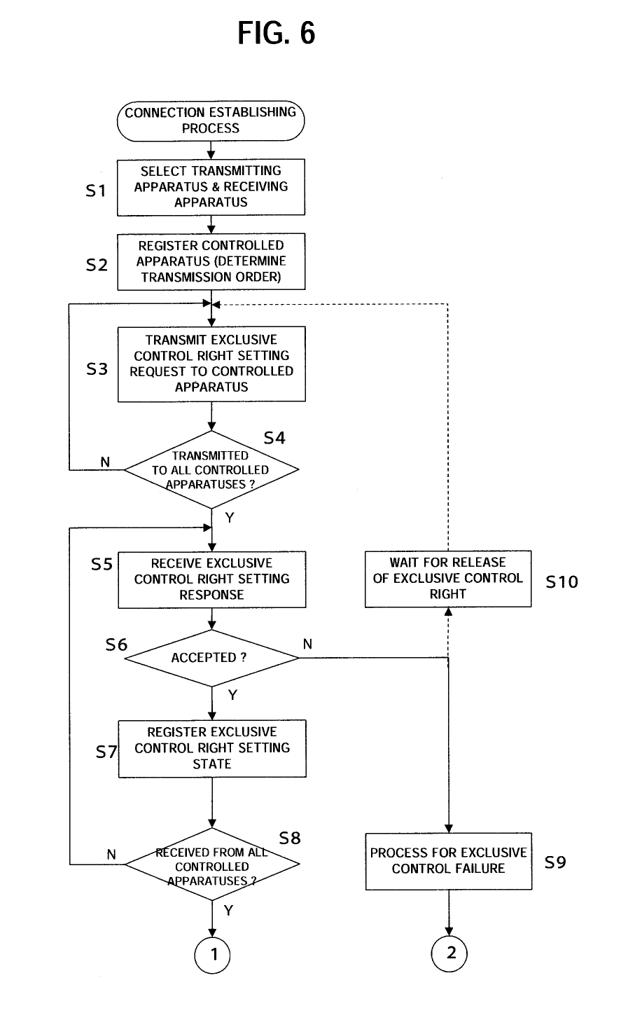

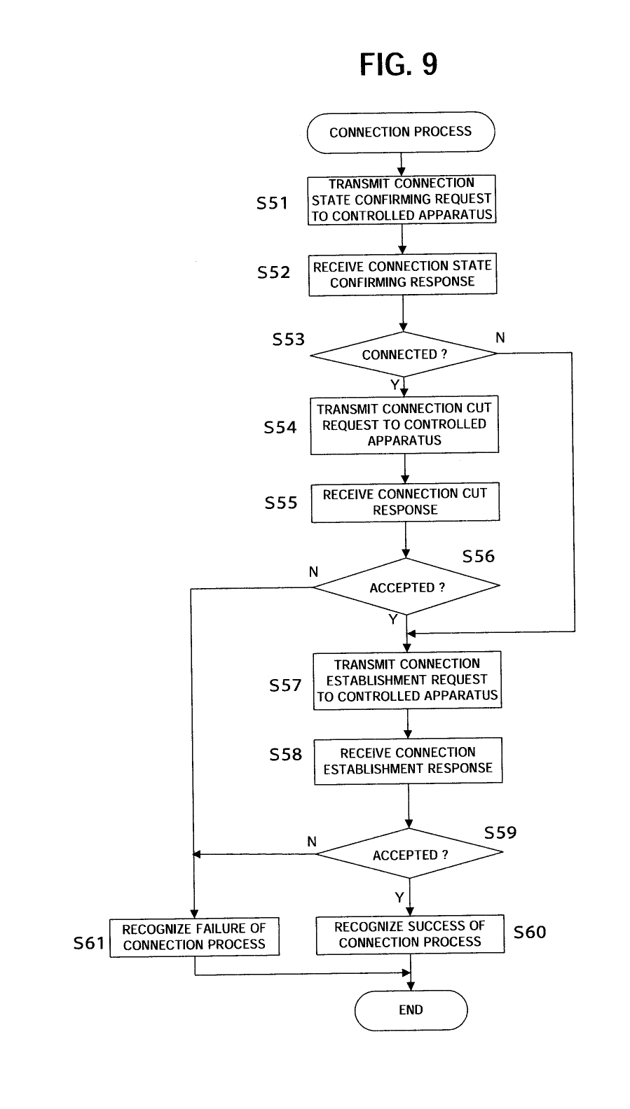

Next, the connection establishing process by the controller of this embodiment will be described with reference to FIGS. 5 to 9. FIG. 5 is a sequence diagram of the connection establishing process by the car AV system 1. FIGS. 6 to 8 are flowcharts of the connection establishing process by the controller, and FIG. 9 is a flowchart of the connection process executed in the connection establishing process.

The connection establishing process is to exclusively control a plurality of controlled apparatuses and then establishes a plurality of associated connections, in a series of control sequence over a plurality of apparatuses. In this embodiment, it is assumed that the user performs the operation of watching the DVD by the R-monitor 15 and the amplifier 17, by using the F-monitor 11 as the controller. In this case, the DVD player 12 is selected as the audio transmitting apparatus and the video transmitting apparatus, the amplifier 17 is selected as the audio receiving apparatus, and the R-monitor 15 is selected as the video receiving apparatus. The F-monitor 11 serving as the controller executes the connection establishing process to establish the audio connection between the DVD player 12 and the amplifier 17 and the video connection between the DVD player 12 and the R-monitor 15, respectively. By this, the user can watch the DVD by using the R-monitor 15 and the amplifier 17.

As shown in FIG. 6, the exclusive control right setting unit 201 of the control unit 200, that the F-monitor 11 functioning as the controller has, first selects the transmitting apparatus and the receiving apparatus designated by the user (step S1). Then, the exclusive control right setting unit 201 registers all of the controlled apparatuses to which the exclusive control right is to be set (step S2). At this time, the transmission order setting unit may set the order of transmitting the exclusive control right setting requests to all of the controlled apparatuses to which the exclusive control right is to be set. Then, the exclusive control right setting unit 201 transmits the exclusive control right setting request to the controlled apparatus in accordance with the order set by the transmission order setting unit (step S3). Namely, the exclusive control right setting unit 201 sets the exclusive control to the controlled apparatus.

Subsequently, the exclusive control right setting unit 201 determines whether or not the exclusive control right setting request is transmitted to all of the controlled apparatuses (step S4). If the exclusive control right setting request is not transmitted to all of the controlled apparatuses (step S4; No), the exclusive control right setting unit 201 repeatedly executes the process of steps S3 and S4. On the contrary, if the exclusive control right setting request is transmitted to all of the controlled apparatuses (step S4; Yes), the exclusive control right setting unit 201 receives, from the controlled apparatus, the exclusive control right setting response indicating that the exclusive control right setting request is accepted or rejected (step S5).

The exclusive control right setting unit 201 determines whether or not the exclusive control right setting request is accepted (step S6). If the exclusive control right setting request is rejected (step S6; No), the exclusive control right setting unit 201 executes the polling of the controlled apparatuses until the exclusive control right can be set (e.g., until the exclusive control right already being set is released) if the exclusive control right setting request can be retried, and transmits the exclusive control right setting request again when the setting of the exclusive control right becomes possible (step S10). By this, when the setting of the exclusive control right is failed, the setting of the exclusive control right can be continued without requesting the source selecting operation again to the user. On the contrary, if the exclusive control right setting request cannot be retried, the control sequence ending unit 209 ends the control sequence as the process for exclusive control failure (step S9).

When the exclusive control right setting request is accepted (step S6), the exclusive control right setting unit 201 registers the exclusive control right setting state (step S7). Then, the exclusive control right setting unit 201 determines whether or not it receives the exclusive control right setting response from all of the controlled apparatuses (step S8). When the exclusive control right setting unit 201 does not receive the exclusive control right setting response from all of the controlled apparatuses (step S8; No), it repeatedly executes the process of steps S5 to S8. On the contrary, when the exclusive control right setting unit 201 receives the exclusive control right setting response from all of the controlled apparatuses (step S8; Yes), it stores the history of the success/failure of the exclusive control right setting request in the history storage unit 202, and the control unit 200 executes the connection process (step S11).

Specifically, by the process so far, the exclusive control right setting unit 201 of the F-monitor registers, as the controlled apparatus, the amplifier 17 which is the audio receiving apparatus and the R-monitor 15 which is the video receiving apparatus. Then, as shown in FIG. 5, the exclusive control right setting unit 201 transmits the exclusive control right setting request to the amplifier 17, first, in accordance with the transmission order set by the transmission order setting unit. When the amplifier 17 accepts the exclusive control right setting request, the exclusive control right setting unit 201 receives, from the amplifier 17, the exclusive control right setting response indicating that the request is accepted (ACCEPTED). Subsequently, the exclusive control right setting unit 201 transmits the exclusive control right setting request to the R-monitor 15 in accordance with the transmission order. When the R-monitor 15 accepts the exclusive control right setting request, the exclusive control right setting unit 201 receives, from the R-monitor 15, the exclusive control right setting response indicating that the request is accepted (ACCEPTED). When receiving the exclusive control right setting response indicating that the request is accepted (ACCEPTED) from all of the registered controlled apparatuses, the control unit 200 executes the connection process.

In the connection process, as shown in FIG. 9, the connection state confirming unit 203 transmits the connection state confirming request to the controlled apparatus (step S51). Then, the connection state confirming unit 203 receives, from the controlled apparatus, the connection state confirmation response indicating the connection state (step S52). Then, the connection state confirming unit 203 determines whether or not the controlled apparatus has already established the connection, i.e., being connected, with another controlled apparatus, based on the connection state confirmation response received from the controlled apparatus (step S53). When the controlled apparatus is not being connected (step S52; No), the control unit 200 goes to step S57. On the contrary, when the controlled apparatus is being connected (step S52; Yes), the connection cut requesting unit 204 transmits the connection cut request, requesting to cut the connection already being established, to the controlled apparatus (step S54). When receiving the connection cut request, the controlled apparatus cuts the connection being established at that time. Then, the controlled apparatus transmits the connection cut response indicating that the connection cut request is accepted and the connection is cut or that the connection cut request is rejected and the connection is not cut.

The connection cut response unit 205 receives the connection cut response from the controlled apparatus (step S55). Subsequently, the connection cut response unit 205 determines whether or not the connection cut request is accepted, based on the connection cut response received from the controlled apparatus (step S56). When the connection cut request is rejected (step S56; No), the control unit 200 recognizes the failure of the connection process (step S61). On the contrary, when the connection cut request is accepted (step S56; Yes), the connection establishment requesting unit 206 transmits, to the controlled apparatus, the connection establishment request to establish the connection with the transmitting apparatus (step S57). When receiving the connection establishment request, the controlled apparatus establishes the connection between the input plug of the controlled apparatus itself and the output plug of the transmitting apparatus. Then, the controlled apparatus transmits the connection establishment response indicating that the connection establishment request is accepted and the connection is established or that the connection establishment request is rejected and the connection is not established.

The connection establishment response unit 207 receives the connection establishment response from the controlled apparatus (step S58). Subsequently, the connection establishment response unit 207 determines whether or not the connection establishment request is accepted, based on the connection establishment response received from the controlled apparatus (step S59). When the connection establishment request is rejected (step S59; No), the control unit 200 recognizes the failure of the connection process (step S61). On the contrary, when the connection establishment request is accepted, the control unit 200 recognizes the success of the connection process (step S60). Thus, the connection process ends.

Specifically, as shown in FIG. 5, in the connection process, the connection state confirming unit 203 transmits the connection state confirming request to the amplifier 17 which is the audio receiving apparatus. In this case, since the amplifier 17 has already established the connection with the DTV 14, the amplifier transmits the connection state confirmation response indicating so (e.g., DTV-AMP). Namely, the connection state confirming unit 203 receives, from the amplifier 17, the connection state confirmation response indicating that the connection has already been established with the DTV 14. Then, the connection cut requesting unit 204 transmits, to the amplifier 17, the connection cut request (the audio connection cut request) to cut the connection already being established with the DTV 14. The amplifier 17 which received the connection cut request executes the audio connection cutting operation to cut the connection being established with the DTV 14. Then, the amplifier 17 transmits the connection cut response indicating that the connection cut request is accepted and the connection is cut (ACCEPTED). Namely, the connection cut response unit 205 receives, from the amplifier 17, the connection cut response (audio connection cut response) indicating that the connection is cut.

Subsequently, as shown in FIG. 5, the connection establishment requesting unit 206 transmits, to the amplifier 17, the connection establishment request (the audio connection establishment request) to establish the connection with the DVD player (expressed as “DVD” in FIG. 5 for convenience) which is the audio transmitting apparatus. The amplifier 17 received the connection establishment request executes the audio connection establishing operation to establish the connection between its input plug and the output plug of the DVD player 12. Then, the amplifier 17 transmits the connection establishment response indicating that the connection establishment request is accepted and the connection is established (ACCEPTED). Namely, the connection establishment response unit 207 receives, from the amplifier 17, the connection establishment response (the audio connection establishment response) indicating that the connection with the DVD player 12 is established.

As shown in FIG. 5, it is now assumed that the exclusive control right setting request is transmitted to the amplifier 17 from the R-monitor 15, other than the F-monitor 11, serving as the controller, during the connection process with the amplifier 17 which is the audio receiving apparatus. In this case, since the F-monitor 11 secures the exclusive control right of the amplifier 17, e.g., it is in the exclusive time period of the connection operation, the amplifier 17 transmits, to the R-monitor 15, the exclusive control right setting response indicating that the exclusive control right setting request is rejected (REJECTED).

As shown in FIG. 5, the connection state confirming unit 203 transmits, to the R-monitor 15 which is the video receiving apparatus, the connection state confirmation request. In this case, since the R-monitor 15 is not establishing the connection with any of the apparatuses, the R-monitor 15 transmits the connection state confirmation response indicating so (e.g., “No Connection”). Namely, the connection state confirming unit 203 receives, from the R-monitor 15, the connection state confirmation response indicating that the connection is not being established with any one of the apparatuses. Then, the connection establishment requesting unit 206 transmits, to the R-monitor 15, the connection establishment request (the video connection establishment request) to establish the connection with the DVD player 12 which is the video transmitting apparatus. The R-monitor 15 which received the connection establishment request executes the video connection establishing operation between its input plug and the output plug of the DVD player 12. Then, the R-monitor 15 transmits the connection establishment response indicating that the connection establishment request is accepted and the connection is established (ACCEPTED). Namely, the connection establishment response unit 207 receives, from the R-monitor 15, the connection establishment response (the video connection establishment response) indicating that the connection with the DVD player 12 is established.

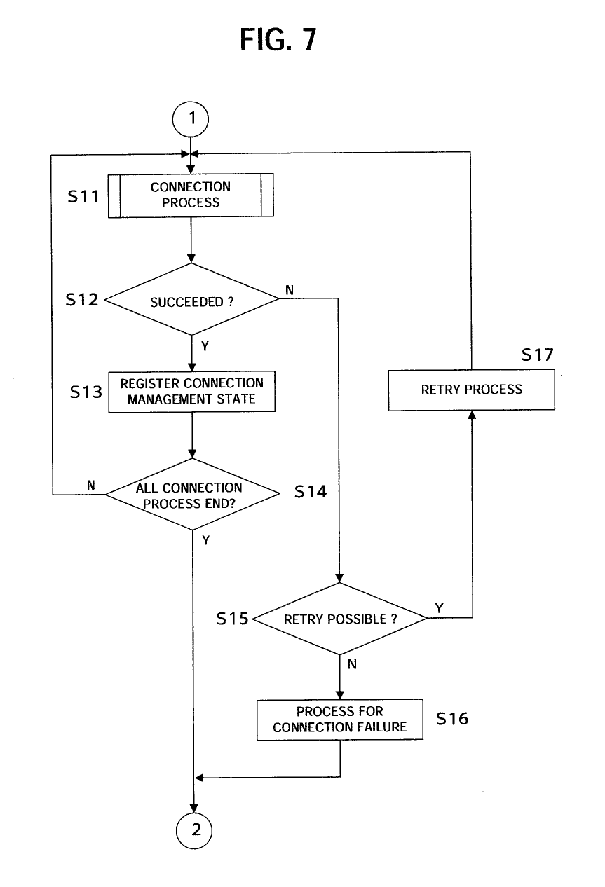

When the connection process ends, as shown in FIG. 7, the connection establishment requesting unit 206 determines whether or not the connection process is succeeded (step S12). When the connection process is failed (step S12; No), the retry determining unit 208 determines whether or not the retry for the connection establishment is possible (step S15). When the retry is possible (step S15; Yes), the connection establishment requesting unit 206 executes the retry process again requesting to establish the connection after a constant waiting time period (step S17). Namely, the connection process is executed again after the constant waiting time period. When the retry is not possible (step S15; No), the control sequence ending unit 209 ends the control sequence as the process for connection failure (step S16). At this time, if there exists a connection successfully established, the control sequence ending unit 209 may end the control sequence after cutting the connection.

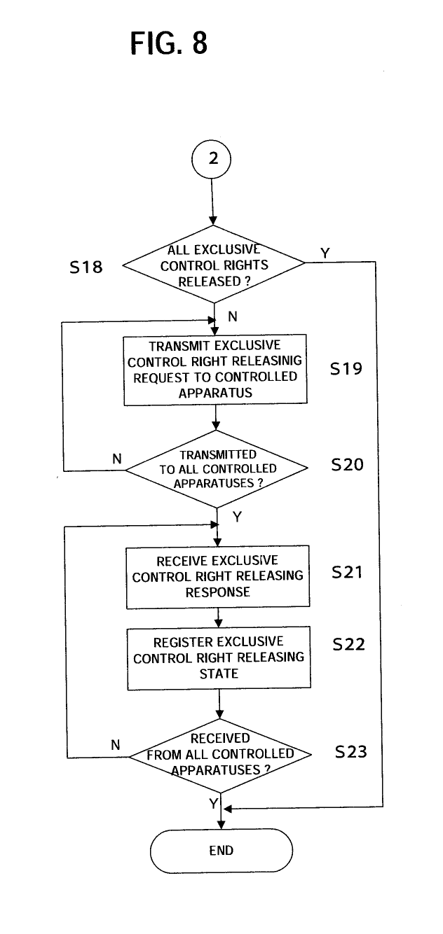

When the connection process is succeeded (step S12; Yes), the connection establishment response unit 207 registers the management state of the established connection (step S13). Then, the connection establishment response unit 207 determines whether or not all the connection process for the controlled apparatus ends (step S14). When all of the connection process does not end (step S14; No), the control unit 200 repeatedly executes the process of steps S11 to S14. On the contrary, when all the connection process ends (step S14; Yes), the control unit 200 goes to step S18 shown in FIG. 8.

Subsequently, as shown in FIG. 8, the exclusive control right releasing unit 210 determines whether or not all of the exclusive control rights set in this control sequence are released (step S18). When all of the exclusive control rights are released (step S18; Yes), the control unit 200 ends the connection establishing process. On the contrary, when all of the exclusive control rights are not released (step S18; No), the exclusive control right releasing unit 210 transmits the exclusive control right releasing request to the controlled apparatuses whose exclusive control right is not released (step S19). Namely, the exclusive control right is released.

Further, the exclusive control right releasing unit 210 determines whether or not the exclusive control right releasing request is transmitted to all of the control apparatuses whose exclusive control right is not released (step S20). When the request is not transmitted to all of the control apparatuses (step S20; No), the exclusive control right releasing unit 210 repeatedly executes the process of steps S19 and S20. On the contrary, when the request is transmitted to all of the controlled apparatuses (step S20; Yes), the exclusive control right releasing unit 210 receives, from the controlled apparatus, the exclusive control right releasing response indicating that the exclusive control right releasing request is accepted or that the exclusive control right releasing request is rejected (step S21). Then, the exclusive control right releasing unit 210 registers the exclusive control right releasing state based on the exclusive control right releasing response received from the controlled apparatus (step S22). Then, the exclusive control right releasing unit 210 determines whether or not it receives the exclusive control right releasing response from all of the controlled apparatuses to which the exclusive control right is set (step S23). When the exclusive control right releasing unit 210 does not receive the response from all of the controlled apparatuses (step S23; No), it repeatedly executes the process of steps S21 to S23. On the contrary, when the exclusive control right releasing unit 210 receives the response from all of the controlled apparatuses (step S23; Yes), the control unit 200 ends the connection establishing process.

Specifically, in the process so far, as shown in FIG. 5, the exclusive control right releasing unit 210 transmits the exclusive control right releasing request to the R-monitor 15 to which the exclusive control right is set to establish the video connection for transmitting the video signal. Then, the R-monitor 15 transmits the exclusive control right releasing response indicating that the exclusive control right releasing request is accepted (ACCEPTED). Also, the exclusive control right releasing unit 210 transmits the exclusive control right releasing request to the amplifier 17 to which the exclusive control right is set to establish the audio connection for transmitting the audio signal. Then, the amplifier 17 transmits the exclusive control right releasing response indicating that the exclusive control right releasing request is accepted (ACCEPTED).

As described above, according to the controller including the control unit 200 of this embodiment, the exclusive control right setting state and the connection establishment state are stored and managed for a plurality of controlled apparatuses subjected to the user's operation, and hence appropriate ending process can be performed even if any of the operation is failed. In other words, it is possible to establish the series of connections necessary for the application without being affected by other controller. Therefore, it is possible to prevent such an inconsistency that, for the video and audio associated with each other, establishing the video connection is succeeded, but establishing the audio connection is failed.

### MODIFIED EXAMPLE

In the above embodiment, the connection establishing process establishes two connections, i.e., the video and the audio connections outputted by the transmitting apparatus. However, the present invention is not limited to this. For example, the present invention is effective for the case that a plurality of connections associated with each other are necessary for a certain application. Specifically, in the clock base jitterless transmission to perform the high sound quality transmission, the receiving apparatus establishes the audio connection and the video connection with the transmitting apparatus and the transmitting apparatus establishes the audio connection with the receiving apparatus to transmit the clock signal. In this case, not only the receiving apparatus, but also the transmitting apparatus becomes the controlled apparatus, and therefore the controller transmits the exclusive control right setting request also to the transmitting apparatus.

By this, not only the connection establishment of only the video and the audio, by transmitting the exclusive control right setting request to the transmitting apparatus with including the connection establishment for transmitting the clock signal at the time of clock base jitterless transmission, all of the connections necessary for this application can be established without being affected by another controller.

In the controlled apparatus received the exclusive control right setting request, not only the exclusive control for the control command, the exclusive control range may be extended by the exclusive control setting request. For the register access to the input plug and the output plug, by making it possible to discriminate the accessed node and to determine the possibility of the register access, the exclusive control may be executed for the register operation. While the above embodiment assumes the connection establishment by the AV/C command such that the controller transmits the “connection establishment request”, it is conceivable that the controller directly executes the connection establishing procedure defined by IEC61883-1 and establishes the connection by the register operation to the input plug and the output plug. In nature, the exclusive control by the AV/C command is to execute the exclusive control for control command by the AV/C, and does not affect the access operation to the register. Therefore, by extending the exclusive control range of the exclusive control right setting request to enable to discriminate the accessed node for the register access to the input plug and the output plug and to determine the allowabillity of the register access, the exclusive control for the register operation is achieved. By this, the problem can be solved based on the flowchart of the above embodiment, in such a case that the controller directly establishes the connection without using the connection establishment request by the AV/C command.

Further, by the exclusive control right setting request, the sound erasing process control (the control of setting the sound volume to mute) for the audio receiving apparatus may be performed at the same time. Similarly, by the exclusive control right setting request, the picture erasing process control for the video receiving apparatus can be performed at the same time. Further, in the exclusive control right releasing request, the sound outputting process control for the audio receiving apparatus may be performed and the picture outputting process control for the video receiving apparatus may be performed. By this, the receiving apparatus may be controlled so as not to reproduce the noise and the noisy picture that may be generated at the time of switching the connection.

### INDUSTRIAL APPLICABILITY

This invention can be used for a car AV system as a control apparatus capable of prevent the inconsistency after processing a plurality of associated connections, by exclusively controlling the plurality of controlled apparatuses in a series of control sequence over the plurality of apparatuses.

1-15. (canceled)

16. A control apparatus which executes, in a network including a plurality of control apparatuses and a plurality of controlled apparatuses, a control sequence to establish connections for transmitting a plurality of associated signals between the plurality of controlled apparatuses, the apparatus comprising:
an exclusive control setting unit which sets an exclusive control to all of the controlled apparatuses related to the control sequence to exclude intervention by other control apparatus, prior to an execution of the control sequence;
a control sequence executing unit which controls the plurality of controlled apparatuses to which the exclusive control is set, and establishes all of the connections for transmitting the plurality of associated signals between the plurality of controlled apparatuses; and
an exclusive control releasing unit which releases all of the exclusive controls set by the exclusive control setting unit after all of the connections are established.

17. The control apparatus according to claim 16,
wherein the signals include a video signal and an audio signal,
wherein the controlled apparatuses include a video receiving apparatus which receives the video signal and an audio receiving apparatus which receives the audio signal,
wherein the exclusive control unit comprises:
a video exclusive control unit which exclusively controls the video receiving apparatus to exclude the intervention by other control apparatus during the control sequence executing period; and
an audio exclusive control unit which exclusively controls the audio receiving apparatus to exclude the intervention by other control apparatus during the control sequence executing period, and
wherein the control apparatus comprises:
a video connection establishment requesting unit which requests, to the video receiving apparatus, to establish the connection with a video transmitting apparatus which transmits the video signal; and
an audio connection establishment requesting unit which requests, to the audio receiving apparatus, to establish the connection with an audio transmitting apparatus which transmits the audio signal.

18. The control apparatus according to claim 17,
wherein the signals include a clock signal for clock base jitterless transmission,
wherein the controlled apparatus is the audio transmitting apparatus,
wherein the audio exclusive control unit exclusively controls the audio transmitting apparatus to exclude the intervention by other control apparatus during the control sequence executing period, and
wherein the audio connection establishment requesting unit requests, to the audio transmitting apparatus, to establish the connection with the audio receiving apparatus.

19. The control apparatus according to claim 17,
wherein the exclusive control releasing unit comprises:
a video connection establishment response unit which receives, from the video receiving apparatus, a response indicating that the connection with the video transmitting apparatus is established;
an audio connection establishment response unit which receives, from the audio receiving apparatus, a response indicating that the connection with the audio transmitting apparatus is established;
a video exclusive control releasing unit which releases a exclusive control of the video receiving apparatus immediately after the video connection establishment response unit receives the response; and
an audio exclusive control releasing unit which releases the exclusive control of the audio receiving apparatus immediately after the audio connection establishment response unit receives the response.

20. The control apparatus according to claim 17, wherein the exclusive control unit includes an order setting unit which sets an order of exclusive control for all of the controlled apparatuses related to the control sequence, and exclusively controls the controlled apparatuses in accordance with the order set by the order setting unit to excludes the intervention by other control apparatus.

21. The control apparatus according to claim 20, wherein the order setting unit sets the order of the controlled apparatus, which easily causes conflict in the connection establishment, to have a high priority.

22. The control apparatus according to claim 22, wherein the order setting unit sets the order such that the order of the receiving apparatus is prior to the order of the transmitting apparatus.

23. The control apparatus according to claim 20,
wherein the control apparatus includes a history storage unit which stores a history of success/failure of the exclusive control of the controlled apparatus by the exclusive control unit, and
wherein the order setting unit sets the order of the controlled apparatus, for which the exclusive control is rejected with high probability, to have a high priority, based on the history stored in the history storage unit.

24. The control apparatus according to claim 17,
wherein, when the video transmitting apparatus includes a plurality of internal sources, the video connection establishment requesting unit designates any one of the internal sources and requests to establish the connection with the designated internal source as the video transmitting apparatus, and
wherein, when the audio transmitting apparatus includes a plurality of internal sources, the audio connection establishment requesting unit designates any one of the internal sources and requests to establish the connection with the designated internal source as the audio transmitting apparatus.

25. The control apparatus according to claim 17, further comprising:
a retry determining unit which determines whether retry of connection establishment is possible or not, based on failure factor, when the connection establishment is failed; and
a control sequence ending unit which ends the control sequence when the retry determining unit determines that the retry is not possible,
wherein the video connection establishment requesting unit and/or the audio connection establishment requesting unit again requests the connection establishment after a constant waiting time passes, when the retry determining unit determines that the retry is possible.

26. The control apparatus according to claim 16,
wherein the signals include an audio signal and a clock signal for clock base jitterless transmission,
wherein the controlled apparatuses includes an audio receiving apparatus which receives the audio signal and an audio transmitting apparatus which transmits the audio signal, and
wherein the exclusive control unit includes:
an audio exclusive control unit which exclusively controls the audio receiving apparatus and the audio transmitting apparatus to exclude the intervention by other control apparatus, during a control sequence executing period;
a first audio connection establishment requesting unit which requests the audio receiving apparatus to establish the connection with the audio transmitting apparatus; and
a second audio connection establishment requesting unit which requests the audio transmitting apparatus to establish the connection with the audio receiving apparatus.

27. The control apparatus according to claim 16, wherein the control sequence is to establish the connections for transmitting the video signal and the audio signal associated with each other separately for each of the signals.

28. A control method executed by a control apparatus which executes, in a network including a plurality of control apparatuses and a plurality of controlled apparatuses, a control sequence to establish connections for transmitting a plurality of associated signals between the plurality of controlled apparatuses, the method comprising:
an exclusive control setting process which sets an exclusive control to all of the controlled apparatuses related to the control sequence to exclude intervention by other control apparatus, prior to an execution of the control sequence;
a control sequence executing process which controls the plurality of controlled apparatuses to which the exclusive control is set, and establishes all of the connections for transmitting the plurality of associated signals between the plurality of controlled apparatuses; and
an exclusive control releasing process which releases all of the exclusive controls set by the exclusive control setting unit after all of the connections are established.

29. A control program executed by a control apparatus which executes, in a network including a plurality of control apparatuses and a plurality of controlled apparatuses, a control sequence to establish connections for transmitting a plurality of associated signals between the plurality of controlled apparatuses, the program makes the control apparatus to function as:
an exclusive control setting unit which sets an exclusive control to all of the controlled apparatuses related to the control sequence to exclude intervention by other control apparatus, prior to an execution of the control sequence;
a control sequence executing unit which controls the plurality of controlled apparatuses to which the exclusive control is set, and establishes all of the connections for transmitting the plurality of associated signals between the plurality of controlled apparatuses; and
an exclusive control releasing unit which releases all of the exclusive controls set by the exclusive control setting unit after all of the connections are established.

30. A storage medium which stores the control program according to claim 29.

31. A network system comprising:
a plurality of control apparatuses and a plurality of controlled apparatuses connected to communicate with each other via a network; and
a control apparatus which executes, to the plurality of controlled apparatuses, a control sequence to establish connections for transmitting a plurality of associated signals between the plurality of controlled apparatuses,
wherein the control apparatus comprises:
an exclusive control setting unit which sets an exclusive control to all of the controlled apparatuses related to the control sequence to exclude intervention by other control apparatus, prior to an execution of the control sequence;
a control sequence executing unit which controls the plurality of controlled apparatuses to which the exclusive control is set, and establishes all of the connections for transmitting the plurality of associated signals between the plurality of controlled apparatuses; and
an exclusive control releasing unit which releases all of the exclusive controls set by the exclusive control setting unit after all of the connections are established.
